(19) United States
(12) Patent Application Publication
(10) Pub. No.: US 2007/0289461 A1
(43) Pub. Date: Dec. 20, 2007

(54) Printing Machine Having at Least One Printing Unit for Imprinting a Web of Material to Be Imprinted by Offset Printing in a Variable Cut Length and a Folder

(76) Inventors: Andreas Ewald Heinrich Bernard, Sulzfeld (DE); Anton Franz Ernt, Neustadt (DE); Helmut Holm, Erlabrunn (DE); Wolfgang Joos, Speyer (DE); Peter Wilhelm Kurt Leidig, Frankenthal (DE); Georg Schneider, Wurzburg (DE); Martin Heinz Schoeps, Guntersleben (DE); Anton Weis, Lorsch (DE); Kurt Johannes Weschenfelder, Zell/Main (DE)

Correspondence Address: Douglas R. Hanscom;Jones, Tullar & Cooper, P.O.Box 226 Eads Station, Arlington, VA, 22202, US

(21) Appl. No.: 10/587,049

(22) PCT Filed: Jan. 28, 2005
(86) PCT No.: PCT/EP05/50374

§ 371 Date: May 11, 2007

(30) Foreign Application Priority Data
May 3, 2004 (DE) 102004021608.8
Feb. 20, 2004 (DE) 102004008788.1
Jan. 31, 2004 (DE) 102004004946.7

(51) Int. Cl. B41F 13/56

(52) U.S. Cl. 101/217

(57) ABSTRACT

A printing machine has at least one printing unit on which a web of material, which is to be imprinted, is imprinted by offset printing in a variable cut length. A folder is mounted downstream, in the direction of travel of the printed web, of the at least one printing unit. The folder may be located directly or indirectly from the at least one printing unit and has a variable cut length.

### CROSS-REFERENCE TO RELATED APPLICATIONS

This patent application is the U.S. national phase, under 35 USC 371, of PCT/EP2005/050374, filed Jan. 28, 2005; published as WO 2005/108262 A1 on Nov. 17, 2005; and claiming priority to DE 10 2004 021 608.8, filed May 3, 2004; to DE 10 2004 008 788.1, filed Feb. 20, 2004 and to DE 10 2004 004 946.7, filed Jan. 31, 2004, the disclosures of which are expressly incorporated herein by reference.

### FIELD OF THE INVENTION

The present invention is directed to a printing press with at least one printing unit for imprinting a web of material to be imprinted by offset printing at a variable section length and a folder. At least one folding apparatus, whose section length can be changed, is assigned to the printing unit.

### BACKGROUND OF THE INVENTION

Printing installations can be operated for offset printing and allow printing of variable section lengths. This is done in order to increase, in this way, variability with respect to the printed products to be manufactured.

EP 0 956 973 A2 described a printing press with at least one printing unit, by the use of which, a material to be imprinted, and of variable section length, can be printed. In the course of this printing, a folding apparatus for variable section lengths can be employed.

EP 0 257 390 A and WO 03/070612 A1 disclose folding apparatuses for variable formats.

U.S. Pat. No. 5,060,569, EP 308 942 A2 and EP 315 917 A2 show printing units which have interchangeable modules.

### SUMMARY OF THE INVENTION

The object of the present invention is directed to providing a printing press with at least one printing unit for imprinting a material to be imprinted, by offset printing with variable section lengths and with a folding apparatus.

In accordance with the present invention, this object is attained by the provision of a printing press, with at least one printing unit, on which a web can be printed in variable section lengths by offset printing. At least one folding apparatus, whose section length can be changed, is assigned to the printing unit. The printing unit includes a frame on which interchangeable modules can be fastened. At least one forme cylinder and/or at least one transfer cylinder of different diameter is seated in different modules. At least one independent drive motor for the folding apparatus as a positionally-regulated electric motor is provided.

An advantage of the printing installation in accordance with the present invention lies, in particular, in that a folding apparatus, which permits folding at a variable section length, is indirectly or directly arranged downstream of the printing unit. It is possible, in this way, to match the fold section length to the printed section length, by which, a highly efficient production of printed products is made possible.

### BRIEF DESCRIPTION OF THE DRAWINGS

Preferred embodiments of the present invention are represented in the drawings and will be described in greater detail in what follows.

Shown are in:

FIG. 1, a schematic top plan view of a structure of a printing installation in

FIG. 2, a first section of the printing installation in accordance with FIG. 1, in a side elevation view, in

FIG. 3, a second section of the printing installation in accordance with FIG. 1, in a side elevation view, in

FIG. 4, a third section of the printing installation in accordance with FIG. 1, in a side elevation view, in

FIG. 5, an alternative embodiment of the third section of the printing installation in accordance with FIG. 1, in

FIG. 6, a schematic side elevation view of a printing unit in a modular construction for use in a printing installation in accordance with the present invention, in

FIG. 7, a transport system for use in conveying modules of printing units in accordance with FIG. 6, in

FIG. 8, a side elevation view of a roll changer for use in a printing installation in accordance with the present invention, in

FIG. 9, a side elevation view of a roll changer with a downstream-connected conditioning device for use in a printing installation in accordance with the present invention, in

FIG. 10, an end view of an asymmetrical superstructure system for use in a printing installation in accordance with FIG. 1, in

FIG. 11, an end view of a symmetrical superstructure system for use in a printing installation in accordance with FIG. 1, in

FIG. 12, an end view of a compact superstructure system for use in a printing installation in accordance with FIG. 1, in

FIG. 13, and end view of an asymmetrical combination superstructure system for use in a printing installation in accordance with FIG. 1, in

FIG. 14, an end view of a superstructure of a former for use in a printing installation in accordance with FIG. 1, in

FIG. 15, schematic depictions of varied product configurations which can be produced in printing installations in accordance with the present invention, in

FIG. 16, a chart detailing different folding apparatus types which can be employed in printing installations in accordance with the present invention, in

FIG. 17, a side elevation view of a first embodiment of a folding apparatus for use in printing installations in accordance with the present invention, in

FIG. 18, a side elevation view of a second preferred embodiment of a folding apparatus for use in printing installations in accordance with the present invention, in

FIG. 19, a side elevation view of a first embodiment of a cutting cylinder pair of a folding apparatus, in

FIG. 20, a second embodiment of a cutting cylinder pair for a folding apparatus, in side elevation, in

FIG. 21, a schematic side elevation view of a variable cover folding apparatus with an envelope supply device, in

FIG. 22, an overview of varied product configurations which can be produced in printing installations in accordance with the present invention, and in

FIG. 23, a representation of folding options which are possible in printing installations in accordance with the present invention.

### DESCRIPTION OF THE PREFERRED EMBODIMENTS

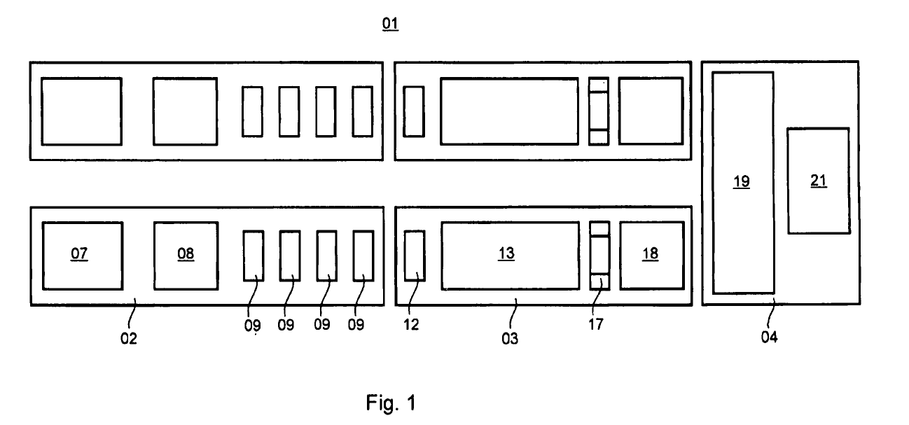

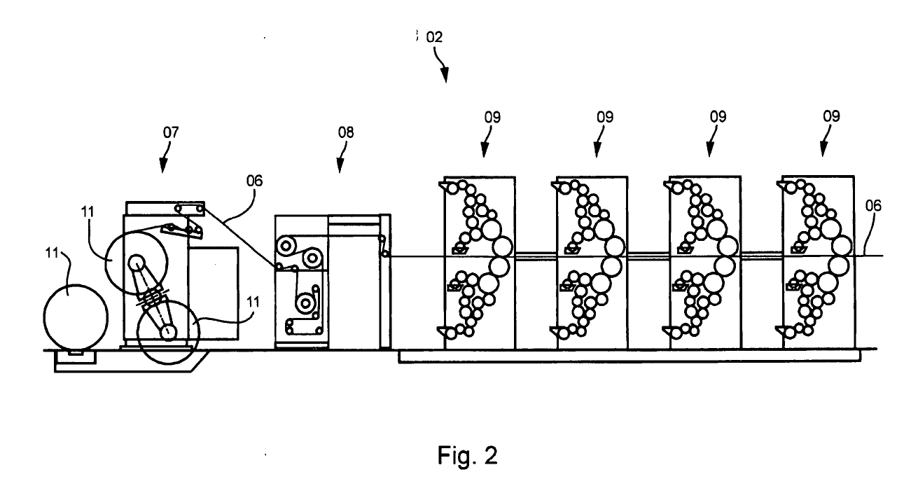

A printing installation 01 is schematically represented, in a top plan view, in FIG. 1. The printing installation 01 is constructed of three sections 02, 03 and 04, through which sections of a web 06 of material to be imprinted, as seen in FIG. 2 successively passes. The web 06 of material to be imprinted can be printed and can then be further processed in a wet offset printing process in the printing installation 01. Alternatively to this, other forms of printing installations are also within the scope of the present invention, when suitable printing units are used, in which the web 06 to be imprinted is printed in, for example, a waterless printing process.

The first section 02 of the printing installation 01 is represented, in a side view, in FIG. 2. A roll changer 07, a web conditioning device 08 and four printing units 09 are located in the first section 02 of the printing installation 01.

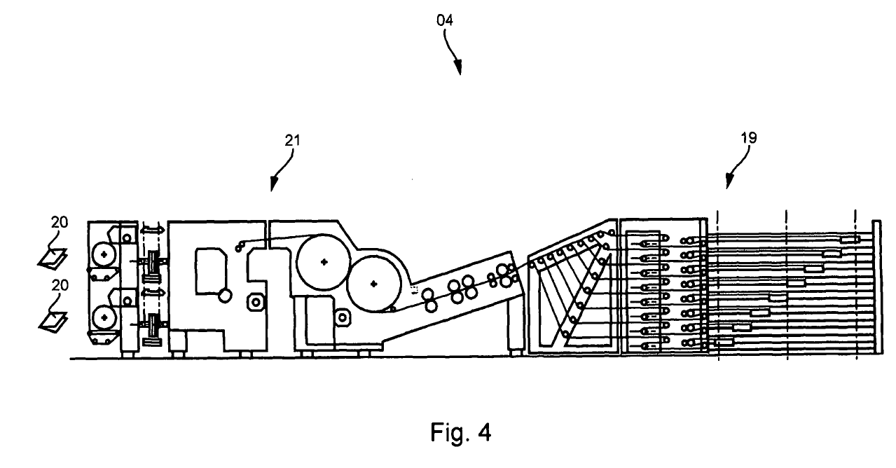

Rolls 11 of material to be imprinted with a width of up to 2520 mm, can be stored in the roll changer 07. The web 06 of material to be imprinted, of the appropriate width of 2520 mm, is subsequently printed in the printing installation 01 and is further processed into a finished printed product 20, as depicted in FIG. 4.

Conditioning of the web 06 to be imprinted takes place in the conditioning device 08. It is possible, in particular, to regulate the web tension of the web 06 to be imprinted by the use of the conditioning device 08. Furthermore, the conditioning device 08 permits the regulation of the web edges of the web 06 to be imprinted. The web to be imprinted is printed on both sides in four colors in the printing units 09, which are arranged one behind the other, in the first section 02 of the printing installation 01.

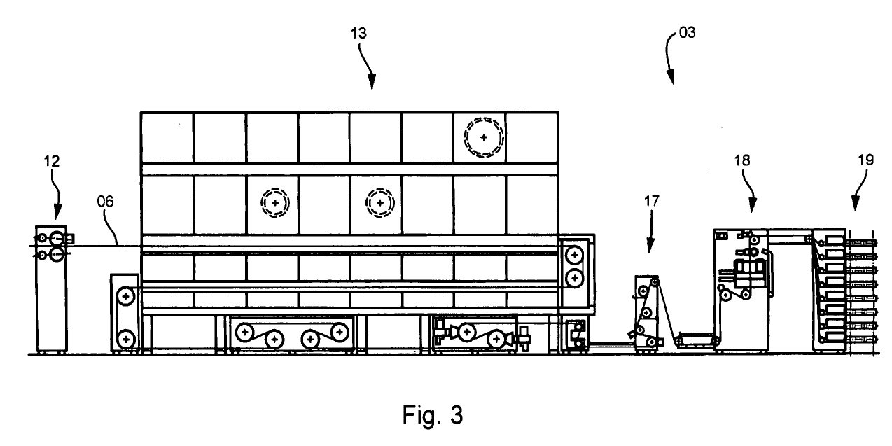

The second section 03 of the printing installation 01 is represented, in a side view, in FIG. 3. After having run through the four printing units 09, the web of material to be imprinted 06 passes through a web-catching device, such as, for example, an intercept roller 12, and is conveyed from there into a drying installation 13, in which drying installation 13, all four print stages of the four printing units 09 are dried together. Heating drums and/or blower nozzles, for example, for use in supplying the required heat, are provided in the drying installation 13. A cooling device 14, with cooling rollers is located on the underside of the drying installation 13, by the use of which cooling device 14, the dried web 06 of material to be imprinted can be cooled. After its passage through the cooling device 14, the web 06 of material to be imprinted reaches a dampening device 16, in which the web 06 to be imprinted is re-moistened.

Upon leaving the drying installation 13, the web 06 to be imprinted is coated with a silicon layer in a coating installation 17. The coated web 06 thereafter arrives in a draw-in and cutting device 18.

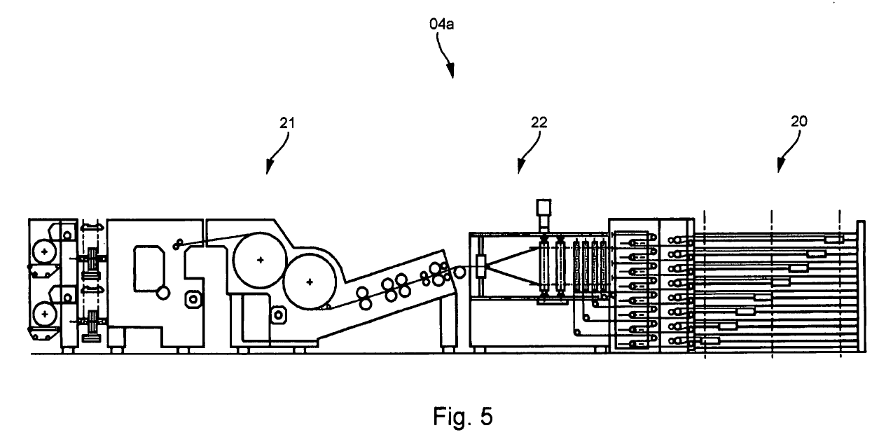

The third section 04 of the printing installation 01 is represented in a schematic view in FIG. 4. From the draw-in and cutting device 18, the web 06 to be imprinted arrives at a turning device 19, which is also shown in FIG. 2. The web 06 is subsequently further processed into printed products 20 in a folding apparatus 21. It is to be noted that FIGS. 4 and 5 are reversed, in the direction of web travel from FIGS. 2 and 3. FIG. 1 shows the proper orientation of the third section 04.

FIG. 5 shows an alternative embodiment of a third section 04a of the printing installation 01. In the alternate third section 04a, a former 22, for use in longitudinally folding the web 06 of material to be imprinted, is interposed between the turning device 19 and the folding apparatus 21.

The structure of a printing installation in accordance with the present invention can be seen, by way of example, in FIG. 1 to FIG. 5. It is, of course, possible to omit individual parts of the installation from the printing installation, or to add additional ones to it, for constructing printing installations in accordance with the present invention. The parts of the printing installation and various functional elements, which are described in what follows, are also to be understood as being merely by way of example for explaining the invention and can, depending on the specific extent of the functions utilized in the printing installation, be added or omitted.

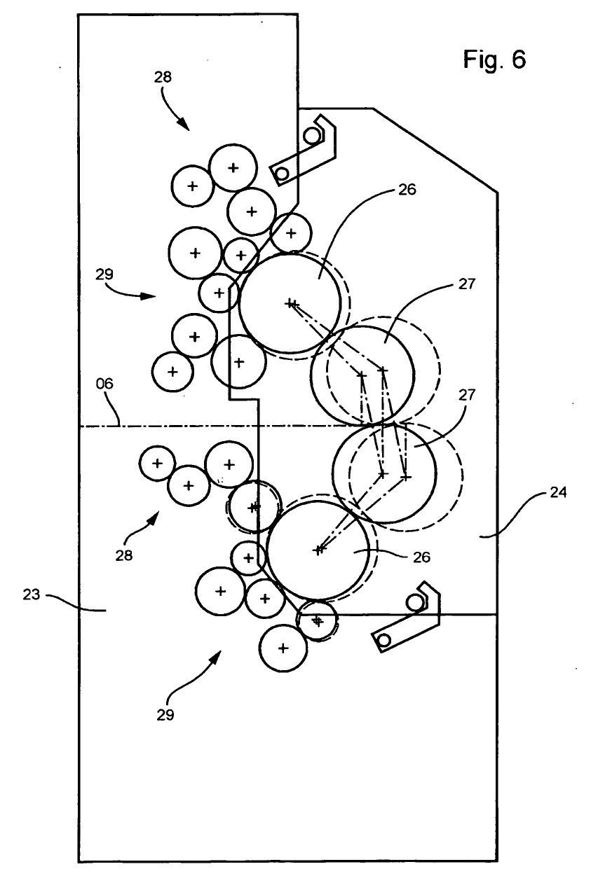

A printing unit 09a, which is embodied in a modular construction, is represented in FIG. 6. The printing unit 09a has a frame 23, in which frame 23 interchangeable modules 24 can be selectively fastened. Forme cylinders 26 and transfer cylinders 27, of different diameters, are provided in the respective different modules 24. For example, several different diameters of the forme cylinder 26 or transfer cylinders 27 of a second module 24 are shown in dashed lines in FIG. 6. By exchanging the modules 24 at the printing units 09a, it is possible that the web 06 to be imprinted will be printed, with different respective section lengths, in the printing installation 01. Exchanging the forme cylinders 26 and the transfer cylinders 27, as a function of the section length which is necessary for performing the respective required printing job, takes place by exchanging the modules 24. Modules 24 should preferably be provided in which the forme cylinders 26 and the transfer cylinders 27 each have a cylinder circumference of between 1100 and 1500 mm, and in particular of 1156 mm, 1260 mm, 1320 mm and/or 1410 mm, for example with six DIN A4 pages, or modules 24 with 1680 mm, 1760 mm, 1880 mm,for example, with six DIN A4 pages.

The forme cylinder 26 preferably has a circumference which corresponds to at least six horizontal DIN A4, and which preferably corresponds to eight DIN A4 pages, and which circumference is correspondingly provided with images. A ratio of the length to the circumference of the forme cylinder 26 preferably is from 1:3 to 1:8, and in particular is from 1:4 to 1:6.

In an advantageous embodiment of the present invention, in a first operating state, and with a first rubber blanket applied, the transfer cylinder 27 has a first diameter, and in a second operating state, with a different rubber blanket applied, the transfer cylinder has a second diameter. The first and second diameters typically differ by at least 5 mm, and preferably vary by at least 10 mm.

The inking system rollers and the damping system rollers are seated in the module 24 by the use of pneumatic roller locks, which are not specifically represented, preferably at least two such roller locks, provided in accordance with the disclosure of WO 02/074542 and having independently operating actuators, and can be simply set in this way. The roller locks are preferably arranged, at least in part, on levers which can be brought into and out of contact, or can be roughly adjusted. A fitting system, which is not specifically depicted, is used in the frame 23 of the printing unit 09a, for use in fixing the module 24 in place in the frame 23 in order to make positionally accurate seating of the module 24, in the frame 23, easily possible. There is a quick-release coupling system for use in supplying the module 24 with air, with water and with electricity, by the use of which, the module 24 can be connected to the air supply, to the water supply and to the electrical supply of the frame 23. The web 06 of material to be imprinted, as schematically depicted in FIG. 6, is conveyed through the printing gap which is formed by the two oppositely located transfer cylinders 07, and is thus printed on both sides by offset printing.

The inking systems 28, or the dampening systems 29, for use in supplying the two forme cylinders 26 with dampening agent and with ink, are each seated in the frame 23. Driving of the various inking system rollers and the various dampening system rollers takes place by the use of a drive mechanism which is present in the frame 23. Furthermore, a separate drive mechanism, for use in driving the forme cylinders 26, or the transfer cylinders 27, is present in the module 24 and can be disconnected from the frame 23, together with the module 24.

It is also possible to provide each cylinder with its own drive motor, or each cylinder pair, consisting of a forme cylinder and rubber blanket cylinder, with its own drive motor.

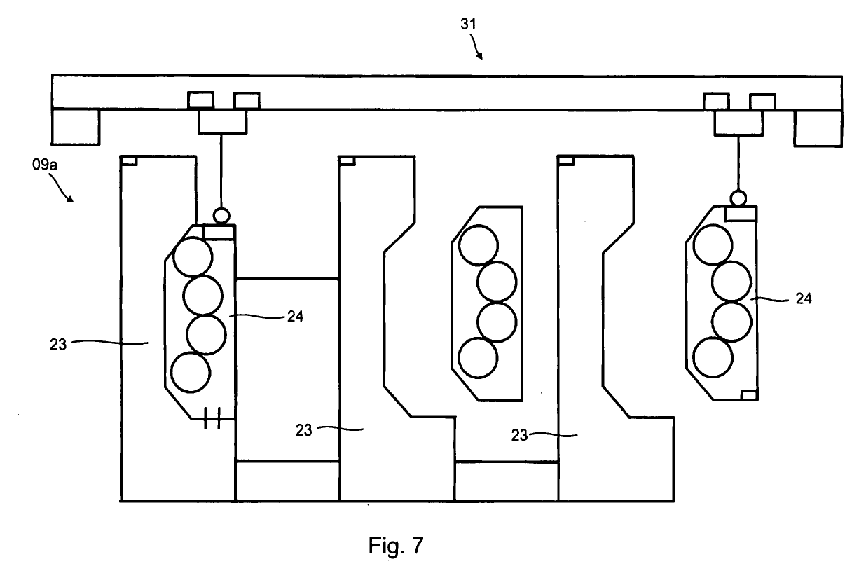

A transport system, for use in exchanging the modules 24, is represented in FIG. 7. The transport system is preferably embodied in the manner of a gantry crane, including a trolley which is initially arranged above, and which is subsequently connected with the module 24 when this module 24 is interchanged. As soon as the module 24 has been coupled to the trolley, the connection of the module 24 with the frame 23 is released and the module 24 is thereafter transported to a suitable storage location. Subsequently, a fresh module 24 is transported to the appropriate frame 23 and is fixed in place there. This is done in order to set up the printing unit for use in printing a web 06 into products having a new section length.

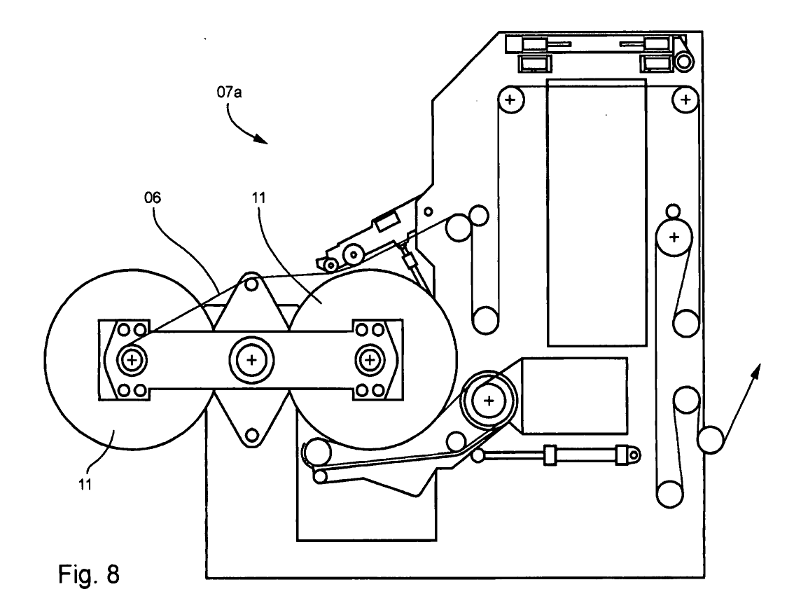

FIG. 8 shows a detailed embodiment 07a of a first roll changer which can be employed in the printing installations, in accordance with the present invention. The roll changer 07a is particularly suitable for receiving exceptionally wide rolls 11 of material 06 to be imprinted. Support straps 32 are provided for supporting the rolls 11 of material to be imprinted in the normal operating position, by the use of which support straps 32, the roll 11 of material to be imprinted can be supported from below. With roll widths of, for example, more than 2000 mm, and in particular with roll widths starting at 2450 mm, the support straps 32 are pushed, from below, against the roll 11 of material to be imprinted, and because of this relieve the core positions by reducing the surface pressure at the clamping mandrel. Interferences, such as burst cores, formation of crépe folds, and lateral excursions of the web of material in the area of the tube close to the tube, are prevented, or are reduced by this. In this case, it is particularly advantageous if the support strap 32 can be driven by the use of a drive mechanism, such as, for example, a rotary current motor, so that the required driving torque, or a portion of the required driving torque can be transmitted to the roll 11 of material to be imprinted by the support straps 32.

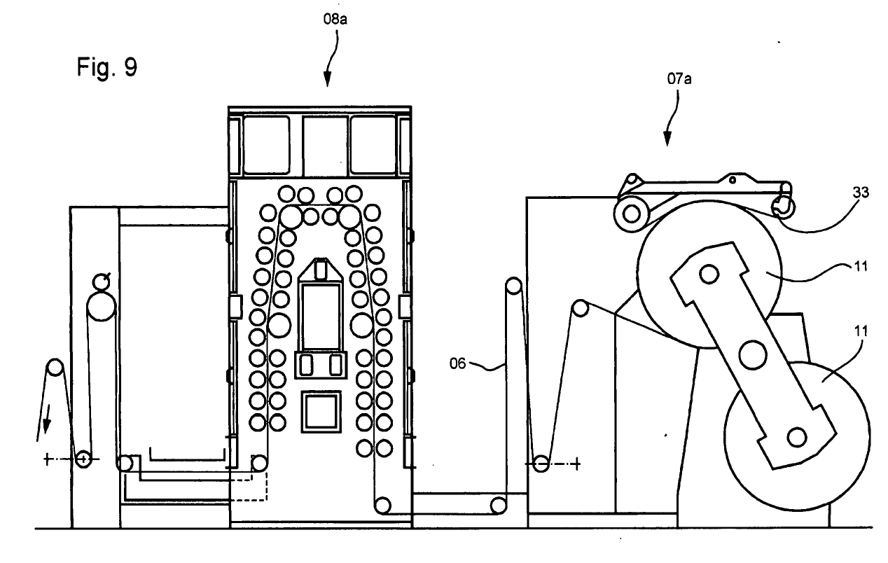

FIG. 9 shows an alternative, second embodiment 07b of a roll changer which is particularly suited for use with web widths of up to 2150 mm. Drive belts 33 are provided at the roll changer 07b, which drive belts 33 come into contact, from above, with the unwinding web 11 of material to be imprinted. It is preferably possible to arrange a second embodiment of a conditioning device 08a downstream of the roll changer 07b. The conditioning device 08a allows the regulation of the web tension by the use of a separate second tensioning system, and furthermore has a web edge regulation system.

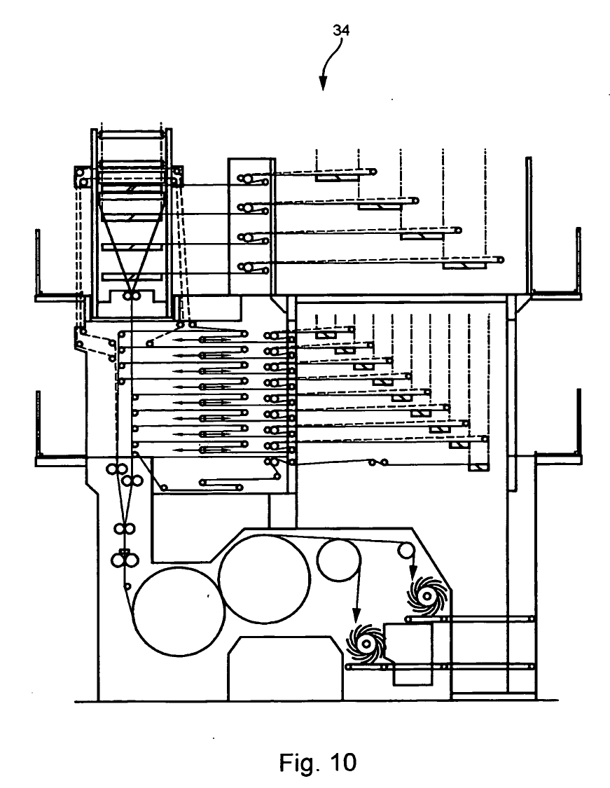

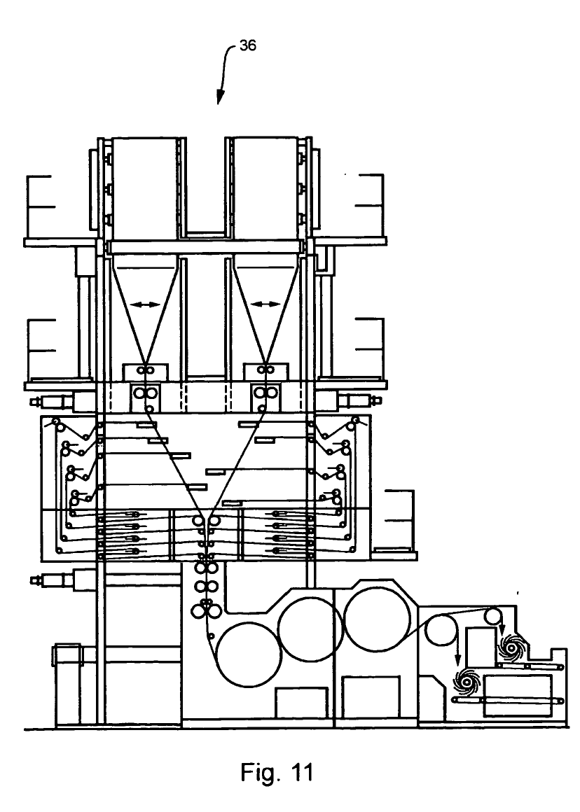

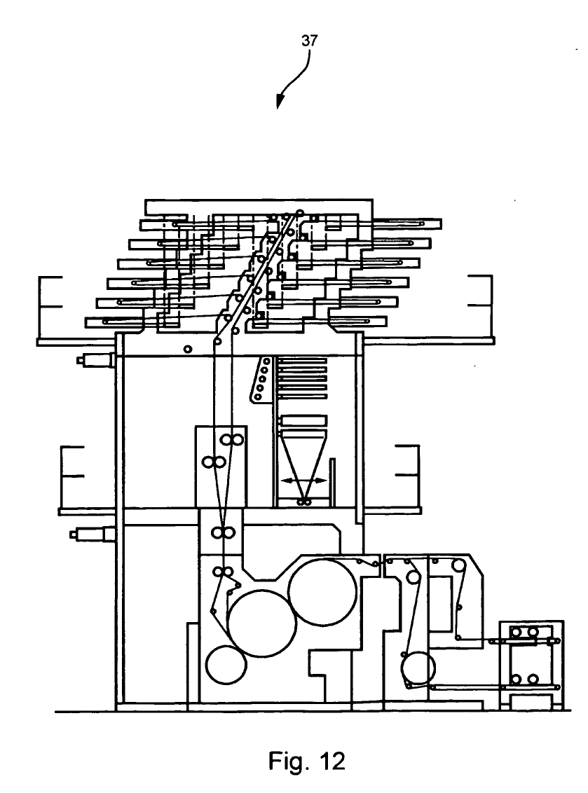

FIG. 10 is a schematic depiction an asymmetrical superstructure system 34 FIG. 11 is a schematic depiction of a symmetrical superstructure system 36. FIG. 12 is a schematic depiction of a compact combined superstructure system 37. These superstructure systems can be additionally combined with printing installations in accordance with the present invention when processing large web widths.

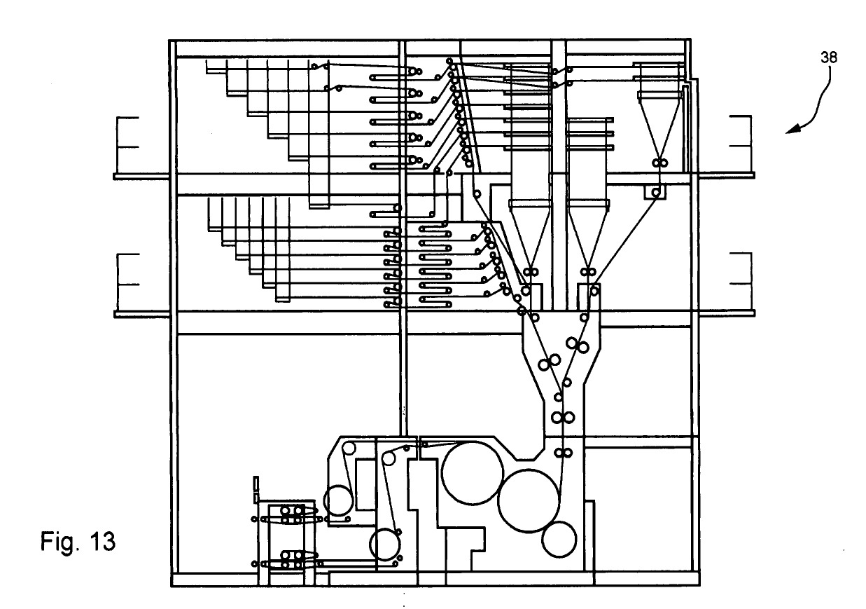

FIG. 13 shows a further embodiment of an asymmetrical combination superstructure system 38, which can be combined with printing installations in accordance with the present invention.

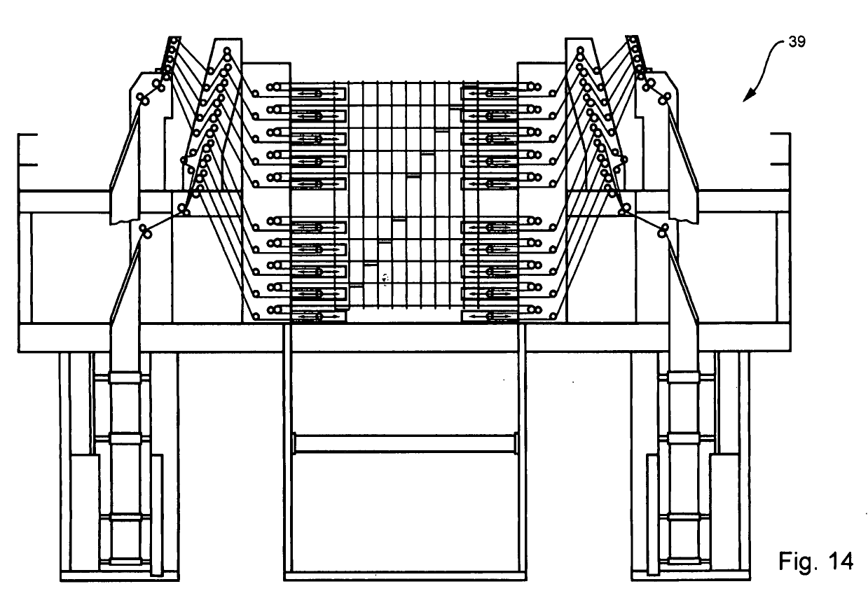

FIG. 14 schematically shows a superstructure system 39, which is embodied in the configuration of a former superstructure with folding apparatuses of small and large format.

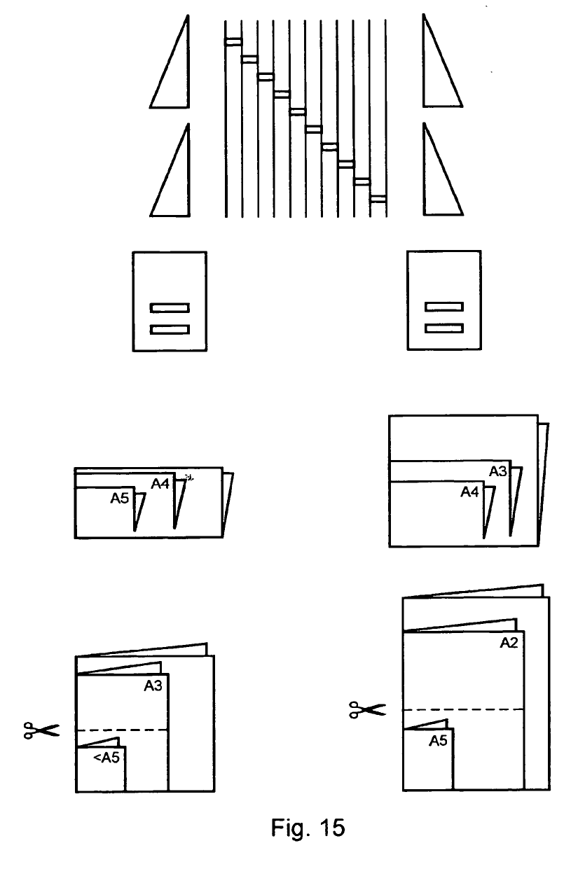

As can be seen in FIG. 15, an extraordinarily large product variety, by the use of offset printing, can be achieved by the combination of formers and turning bars in the superstructure system, as well as in the folding apparatuses for different production in an amount of four, six or eight pages.

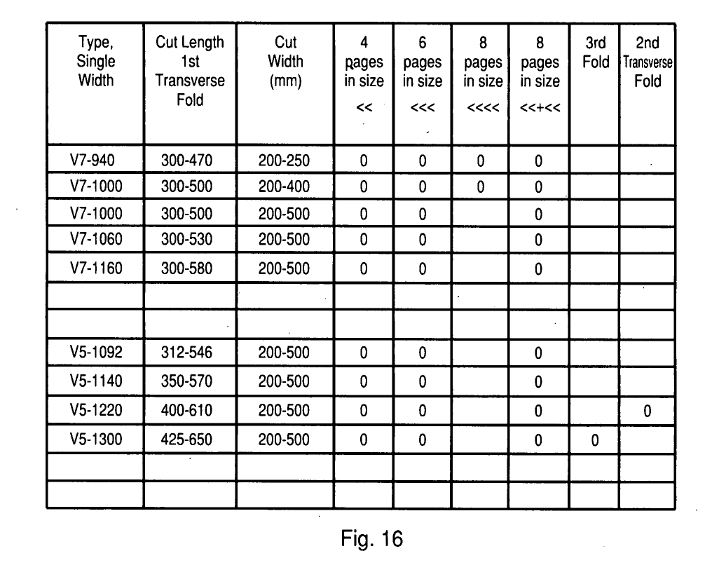

As can be seen in the chart shown in FIG. 16, the insertable cylinder cassettes directly cover the production options by the use of variable folding apparatuses V7-940, V7-1160, V5-1092 and V5-3000.

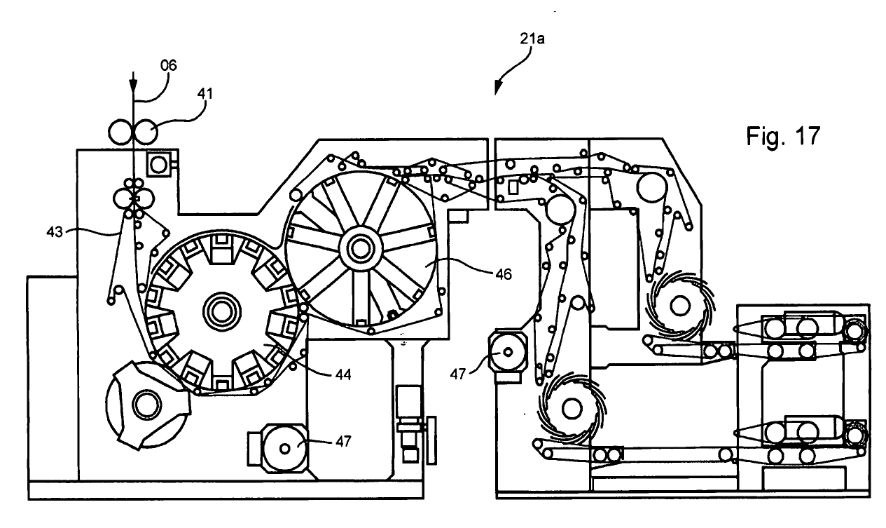

A further embodiment 21a of a variable folding apparatus, with a system 7.7; i.e. a system with seven gripper systems, seven folding blades and seven folding jaws is schematically represented in FIG. 17. The type of such a folding apparatus can also be taken from the disclosure of EP 0 257 390 B1, for example. At the inlet of the web 06 of material to be printed, the folding apparatus 21 a has a traction roller pair 41, by the use of which, the web 06 of material to be imprinted, is electronically charged. The web 06 to be imprinted is cut into individual sheets, in accordance with the predetermined section length, in a cutting roller pair 42, which is located downstream, in the direction of web-travel, of the traction roller pair 41. Acceleration belts 43 are arranged downstream of the cutting roller pair 42, and in which, the individual sheets can be accelerated. The sheets subsequently reach a cylinder 44, and in particular reach a collection cylinder 44 and/or folding blade cylinder 44, and from there are passed on to a folding jaw cylinder 46, which can be provided with springs. The cylinder 44 has two multi-armed instrument supports, which can be displaced with respect to each other. When cutting the printed sheets, to then be folded, it is possible to change the section length of the sheets by adjusting the two instrument supports. Electric motors 47, and in particular electric servo motors 47, are provided for driving the various functional elements of the folding apparatus 21a, which electric motors 47 can be controlled independently of other drive mechanisms for the printing press. The collection cylinder part 44 and the folding jaw or 46 delivery device of the folding apparatus 21a can be driven independently of each other. Preferably, the collection cylinder 44 has folding blade systems and holding systems, such as, for example, gripper systems or spur needle systems, which are arranged on instrument supports. In this case at least 3, but preferably 5 or 7, such gripper systems or spur needle systems are respectively provided here.

A distance between the holding system and the folding blades of the folding blade cylinder 44 can be set as a function of a diameter of a forme cylinder 26 and/or of a transfer cylinder 27 via a control device by, for example, remote control.

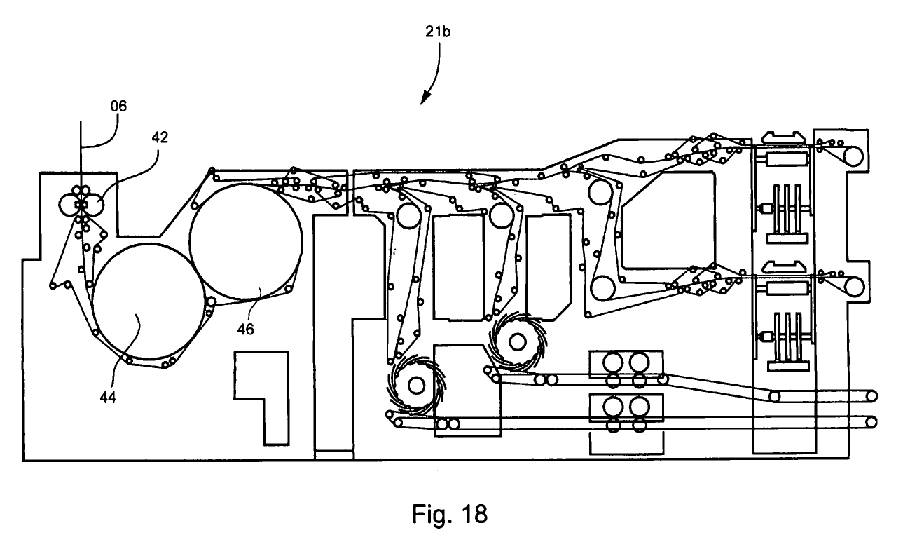

FIG. 18 shows a further embodiment 21b of a folding apparatus which can be employed in printing installations in accordance with the present invention. In this system 5:5, the folding apparatus 21b is constructed with a double third fold and with two transverse fold delivery systems. A cutting roller pair 42 is again provided at the inlet of the folding apparatus 21b. The folding apparatus inlet of the folding apparatus 21b is configured in such a way that the matching of the format of the folding apparatus to that of the printing unit takes place as a function of the section length during offset printing, by operation of the cutting cylinder pair 42, which revolves, with respect to the forme cylinders, at a fixed number of revolution ratio. Depending on the circumferential format, at a defined number of revolutions, the cutting cylinder pair 42 permits continuous webs of greater or of lesser length to pass the transverse cutting group before cutting of the continuous web 06 into the section with the desired length takes place.

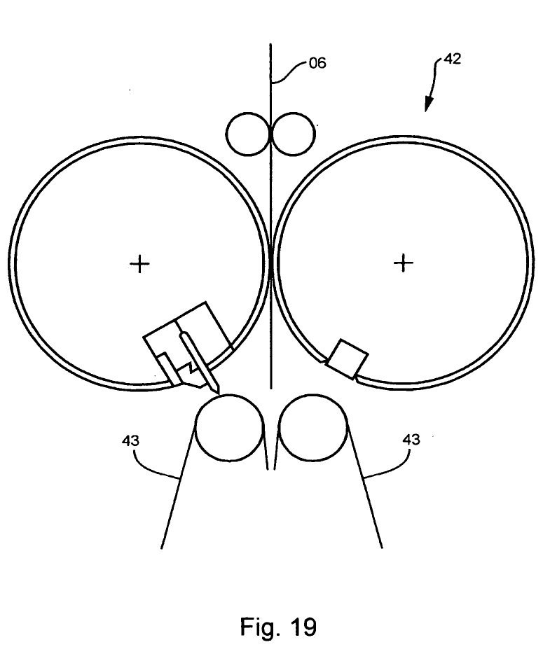

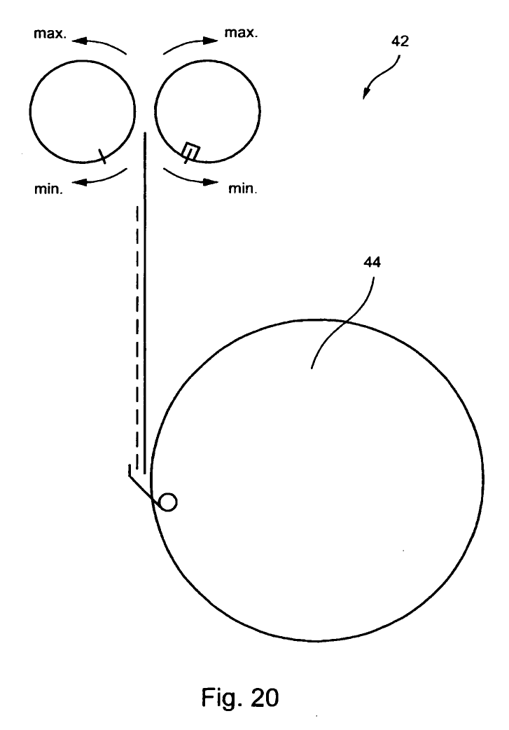

FIG. 19 and FIG. 20 respectively each show a cutting cylinder pair 42, with the start of the acceleration section, for accelerating the sheet to folding cylinder speed. In this case, the cutting cylinder pair 42 can be driven in a clocked manner at the clock rate of the forme cylinders. Alternatively, or in addition thereto, the cutting cylinder pair 42 can be driven at a preset number of revolution ratio with respect to the number of revolutions of the forme cylinders. As a result, it is achieved by this control, that the cutting cylinder pair 42 is driven at a preset speed, independently of the web speed of the web of material to be imprinted in order to vary, in this way, the section length of the folding apparatus 21.

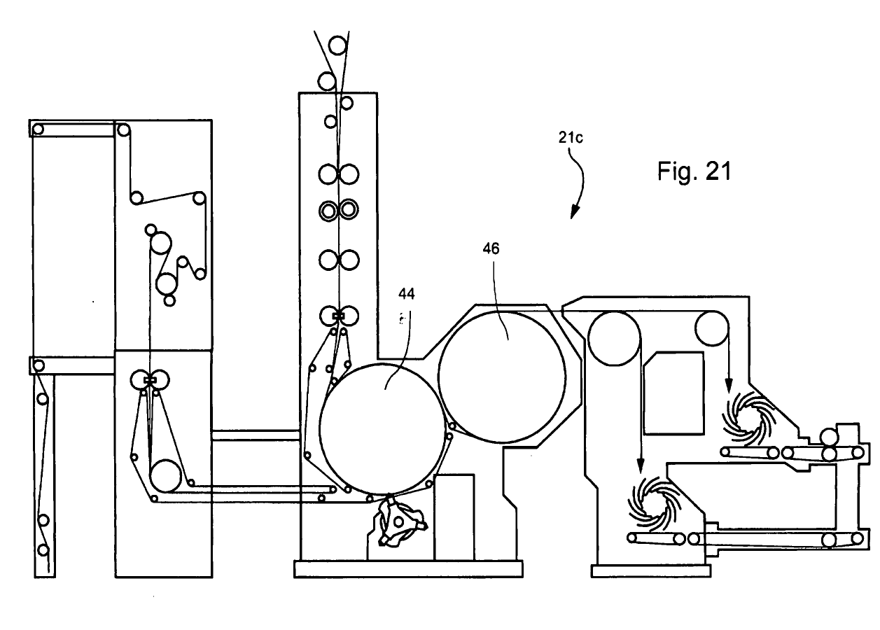

FIG. 21 shows a cover folding apparatus 21c with cover feeding. For example, the production of a magazine, with a cover which is made of heavier and higher quality paper, than is used for the inside of the magazine, normally requires a time-consuming and expensive work step at the collection stitching device during further processing. With the cover folding apparatus 21c depicted in FIG. 21, the pre-printed covers can be fed directly to the printing press. Following stitching and folding, the magazine need only be cut on three sides in the continuous cutter and is ready for delivery after that. At four pages in size, the pre-printed continuous cover web is conducted, at half speed to the cover folding apparatus 21c, where transverse cutting takes place in the feed-in device. Now, the cover is accelerated to the speed of the folding cylinders and is placed on top of the collected inner pages in order to be thereafter stitched and folded together with them.

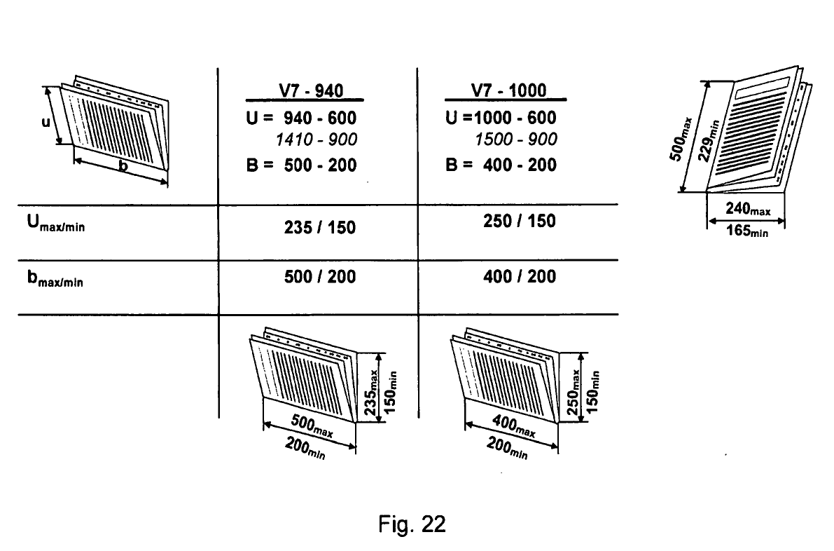

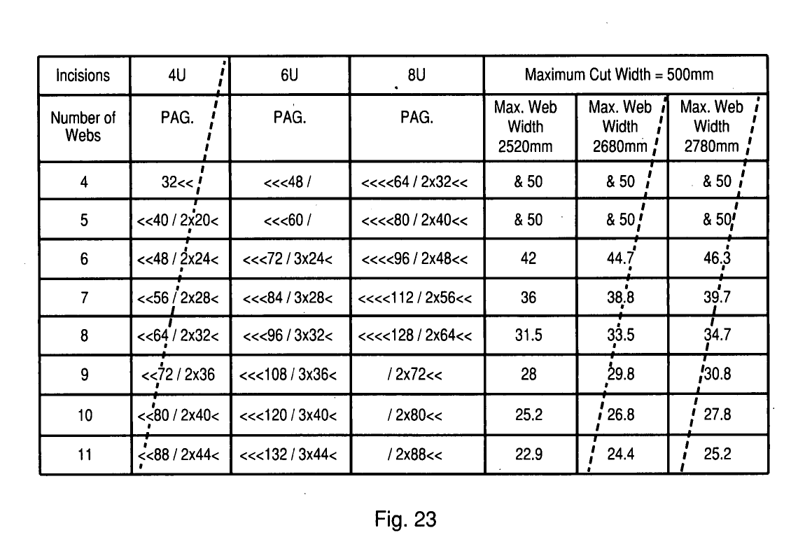

The various possibilities for varying the printing products to be produced in regard to the variable section length of the folding apparatus can be seen in FIGS. 22 and 23.

While preferred embodiments of a printing machine having at least one printing unit for imprinting a web of material to be imprinted by offset printing in a variable cut length, and a former, in accordance with the present invention, have been set forth fully and completely hereinabove, it will be apparent to one of skill in the art that various changes in, for example, the type of material web being printed, the structure of the inking and dampening units, and the like could be made without departing from the true spirit and scope of the present invention, which is accordingly to be limited only by the appended claims.

What is claimed is:

1-68. (canceled)

69. A printing press comprising:
at least first and second printing unit modules, each of said modules including at least one forme cylinder and at least one transfer cylinder, at least one of said forme cylinder and said transfer cylinder in said first printing unit module having a first diameter, at least one of said forme cylinder and said transfer cylinder in said second printing module having a second diameter different from said first diameter; each said printing unit module being usable to print a web of material in offset printing and having a variable print section length;
a printing press frame adapted to selectively receive one of said at least first and second printing unit modules, said web to be inked by said printing press having said variable print section length in accordance with a selected one of said at least first and second printing unit modules that is secured in said printing press frame;
at least one folding apparatus in said printing press and having a folding apparatus section length which is changeable;
at least one positionally regulatable drive motor usable to drive said at least one folding apparatus;
means for separating said web into signatures having said variable print section lengths; and
a folding blade cylinder in said at least one folding apparatus and having at least three signature leading end holding systems and at least three associated folding blades, a distance between each one of said associated holding systems and folding blades being changeable in accordance with said variable print section length.

70. The printing press of claim 69 wherein said means for separating said web includes at least one cutting cylinder pair forming a cutting gap through which said web passes.

71. The printing press of claim 70 wherein said cutting cylinder pair is driven at a preset speed which is independent of a web speed of said web.

72. The printing press of claim 20 wherein said cutting cylinder pair is driven clocked in accordance with a clock rate of at least one of said forme cylinder and said transfer cylinder in said printing unit.

73. The printing unit of claim 2 wherein said cutting cylinder pair is driven at a pre-set ratio of a number of revolutions with respect to a number of revolutions of one of said forme cylinder and said transfer cylinder.

74. The printing unit of claim 69 further including a collection cylinder in said folding apparatus and having two multi-armed instrument supports that are displaceable with respect to said other.

75. The printing press of claim 69 wherein said positionally regulated drive motor for said folding apparatus is independent of other functional elements of said printing press.

76. The printing press of claim 69 wherein said at least one positionally regulated drive motor is a servo motor.

77. The printing press of claim 69 wherein said folding apparatus includes a folding cylinder portion and a delivery cylinder portion each of which is driven independently of the other by a separate drive motor.

78. The printing press of claim 69 further including a folding jaw cylinder, including springs, in said folding apparatus.

79. The printing press of claim 69 further including a folding blade cylinder in said folding apparatus.

80. The printing press of claim 69 wherein said folding apparatus is one of a variable 5:5 system or 7:7 system.

81. The printing press of claim 69 wherein said folding apparatus is a cover folding apparatus.

82. The printing press of claim 69 wherein said printing unit is a web offset printing unit.

83. The printing press of claim 69 wherein said printing unit is a waterless offset printing unit.

84. The printing press of claim 69 wherein each said printing unit module includes selectively interchangeable forme cylinders each having a diameter different from other ones of said selectively interchangeable forme cylinders.

85. The printing press of claim 69 wherein each said printing unit module includes selectively interchangeable transfer cylinders each having a diameter different from other ones of said selectively interchangeable transfer cylinders.

86. The printing press of claim 84 wherein said selectively interchangeable forme cylinders have cylinder circumferences of one of 1156 mm, 1260 mm, 1320 mm and 1410 mm.

87. The printing press of claim 84 wherein said selectively interchangeable transfer cylinders have cylinder circumferences of one of 1156 mm, 1260 mm, 1320 mm and 1410 mm.

88. A printing press comprising:
at least one printing unit adapted to print a web of material in a printed section length that is variable and including a forme cylinder with a forme cylinder diameter and a transfer cylinder with a transfer cylinder diameter;
at least one folding apparatus in said printing press and assigned to said at least one printing unit, said folding apparatus having a folded section length that is variable;
a folding blade cylinder in said folding apparatus and including a holding system and a folding blade;
at least one positionally controlled electric motor usable to drive at least one cylinder of said folding apparatus independently of said printing press; and
a control device usable to set a distance between said holding system and said folding blade of said folding blade cylinder as a function of said diameter of one of said forme cylinder and said transfer cylinder by remote control.

89. The printing press of claim 69 wherein at least one of said forme cylinder and said transfer cylinder is adjustably seated on each said module.

90. The printing press of claim 69 further including at least one of dampening systems and inking systems held in said module by pneumatic roller locks.

91. The printing press of claim 69 further including a fitting system usable to secure said modules in said frame.

92. The printing press of claim 69 further including a quick-release system usable for connecting said module to at least one of air supply and water supply and electrical supply in said frame.

93. The printing press of claim 69 further including two forme cylinders and two transfer cylinders in each of said modules.

94. The printing press of claim 93 further including a satellite cylinder in each of said modules.

95. The printing press of claim 69 wherein at least one of said modules is operable as an imprinter for a flying plate change.

96. The printing press of clam 69 wherein said at least two modules can each be operable as an imprinter for a flying plate change.

97. The printing press of clam 69 further including a module transport system usable with said printing press for transporting a module to and from said frame.

98. The printing press of claim 97 wherein said transport system is a crane.

99. The printing press of claim 69 further including at least one inking system in each said modular printing unit.

100. The printing press of claim 99 further including at least two inking system rollers in each said inking system.

101. The printing press of claim 69 further including at least one dampening system in each said modular printing unit.

102. The printing press of claim 101 further including at least two dampening system rollers in each said dampening system.

103. The printing press of claim 69 further including at least one of inking systems and dampening systems in said printing press frame.

104. The printing press of claim 103 further including an independent drive mechanism for each of said one of inking systems and dampening systems in said printing press frame.

105. The printing press of claim 99 further including an independent drive mechanism for said at least one inking system in said module.

106. The printing press of claim 101 further including an independent drive mechanism for said at least one dampening system in said module.

107. The printing press of claim 104 wherein said independent drive motor is a positionally regulated electric motor.

108. The printing press of claim 69 wherein each said module has a closed oil chamber.

109. The printing press of claim 69 wherein said printing press frame has a closed oil chamber.

110. The printing press of claim 69 wherein said web of material has a width of greater than 2000 mm.

111. The printing press of claim 69 further including four of said printing unit modules in said printing press.

112. The printing press of claim 111 wherein said web of material is printed in several colors in said four printing unit modules.

113. The printing press of claim 69 further including a roll changer.

114. The printing press of claim 113 further including roll support straps in said roll changer and usable to support a roll of said material to be printed.

115. The printing press of claim 114 wherein said roll support straps are driven by means of a drive mechanism.

116. The printing press of claim 69 further including a web conditioning device in said printing press and being usable to regulate at least one of web tension and web edges.

117. The printing press of claim 69 further including a web drying installation in said printing press.

118. The printing press of claim 117 wherein said web of material is dried in said drying installation after having been printed.

119. The printing press of claim 117 further including a web cooling device in said web drying installation and adapted to cool said web of material.

120. The printing press of claim 117 further including a web dampening device in said web drying installation.

121. The printing press of claim 69 further including one of a web draw-in device and a web cutting device in said printing press.

122. The printing press of claim 69 further including a web turning device in said printing press.

123. The printing press of claim 69 further including at least one longitudinal web former in said printing press.

124. The printing press of claim 123 further including at least one web gluing device in said at least one former.

125. The printing press of claim 69 further including a superstructure system in said printing press.

126. The printing press of claim 125 further including at least one of a longitudinal web former and a turning bar in said superstructure system.

127. The printing press of claim 69 further including at least one web interception device in said printing press.

128. The printing press of claim 69 further including at least one web coating device in said printing press.

129. The printing press of claim 128 wherein said coating installation is usable for coating said web of material with a silicon layer.

130. The printing press of claim 69 further including a plurality of said printing presses, operable in parallel, and a common web folding apparatus.

131. The printing press of claim 69 wherein said holding systems are one of gripper systems and spur needle systems.

132. The printing press of claim 69 wherein, in a first operational state, said transfer cylinder supports a first rubber blanket and has a first diameter, and in a second operational state said transfer cylinder supports a second rubber blanket and has a second diameter, said first and second diameters differing by at least 5 mm.

133. The printing press of claim 132 wherein said first and second diameters differ by at least 10 mm.

134. The printing press of claim 69 further including a control system adapted to set said distance between said holding system and said associated folding blade as a function of a forme cylinder diameter.
